(19) United States
(12) Patent Application Publication
(10) Pub. No.: US 2026/0340688 A1
(43) Pub. Date: Oct. 29, 2026

(54) SYSTEMS AND METHODS FOR ROUTING EXPERT CONNECTION REQUESTS

(71) Applicant: INTUIT INC., Mountain View, CA (US)

(72) Inventors: Harshal RAUT, Mountain View, CA (US); Sinu SEKHAR, Mountain View, CA (US); Michael A. ARTAMONOV, Mountain View, CA (US); Abhay GUPTA, Mountain View, CA (US); Louie MATTAR, Mountain View, CA (US); Joshua FRANKLIN, Mountain View, CA (US)

(73) Assignee: INTUIT INC., Mountain View, CA (US)

(21) Appl. No.: 19/191,909

(22) Filed: Apr. 28, 2025

(51) Int. Cl. G06Q 30/02; G06Q 10/0631; G06Q 40/10

(52) U.S. Cl. CPC G06Q 30/0281; G06Q 10/063112; G06Q 40/10

(57) ABSTRACT

A system and method are provided for routing expert connection requests.

### BACKGROUND OF THE DISCLOSURE

Typically, contemporary customer service contact centers focus on customer satisfaction and efficient issue resolution. Customers often prefer to engage with specific experts to address their concerns based on previous interactions or specific expertise. For example, certain users may wish to directly engage with a professional tax expert (or other expert depending on the specific application). However, current systems do not sufficiently ensure that customers can consistently connect with their preferred experts immediately, leading to potential dissatisfaction and inefficiencies.

### BRIEF DESCRIPTION OF THE FIGURES

FIG. 1 is a block diagram of an example system for routing expert connection requests according to example embodiments of the present disclosure.

FIG. 2 is an example flow diagram for routing expert connection requests within the system of FIG. 1 according to example embodiments of the present disclosure.

FIG. 3 is a flowchart of an example process for routing expert connection requests according to example embodiments of the present disclosure.

FIG. 4 is another flowchart of an example process for routing expert connection requests according to example embodiments of the present disclosure.

FIGS. 5-8 are example user interfaces that can be displayed during the processes for routing expert connection requests according to example embodiments of the present disclosure.

FIG. 9 is a diagram of an example computing device or server device.

FIG. 10 is another example of a computing device.

The drawings are not necessarily to scale, or inclusive of all elements of a system, emphasis instead generally being placed upon illustrating the concepts, structures, and techniques sought to be protected herein.

### DESCRIPTION

The following detailed description is merely exemplary in nature and is not intended to limit the claimed invention or the applications of its use.

Embodiments of the disclosure are directed to systems and methods for routing expert connection requests. Specifically, the disclosed systems and methods can enable customers to connect with preferred experts using a pooling system. The pooling system can include various experts selected from a larger plurality of experts who match the customer's requests and kept in a reserved state, such as for a predetermined duration. This can ensure availability for the specific customer while preventing walk-in (i.e., call-in) customers from utilizing those experts. Moreover, the disclosed systems and methods can perform the expert matching functions in an intent-based manner. In other words, the system can predict how likely it actually is that a customer who has sent in a connection request will actually engage in a connection with one of the reserved experts. The resulting pool of experts for the request can then take into account this predicted likelihood.

The disclosed systems and methods offer various technical benefits to the overall customer contact center computing architecture. In particular, the expert reservation and pooling system maintains a high occupancy, which ultimately improves overall network efficiency by preventing false matches and reservations of experts that do not ultimately pan out, optimizes idle time of the experts, and minimizes customer wait times by increasing the speed in which connections can be initiated. These benefits are further enhanced by employing intent-based predictions within the pooling system.

As an illustrative example, if there are a hundred available experts and fifteen customers that are deemed to be high intent, the matching result without any intervention would be choosing fifteen experts for the fifteen customers. This would mean 85% of the expert pool is available for walk-in/call-in customers. However, if there is no resulting engagement between an expert and customer, it has wasted the expert's time and reduced the overall connection efficiency of the network. The disclosed systems and methods can improve these technical deficiencies and inefficiencies by using the disclosed pooling system, where the pool can still be matched with additional customer requests but is prevented from being applied to walk-ins/call-ins. Moreover, the intent-based predictions further reduce the likelihood of failed matches.

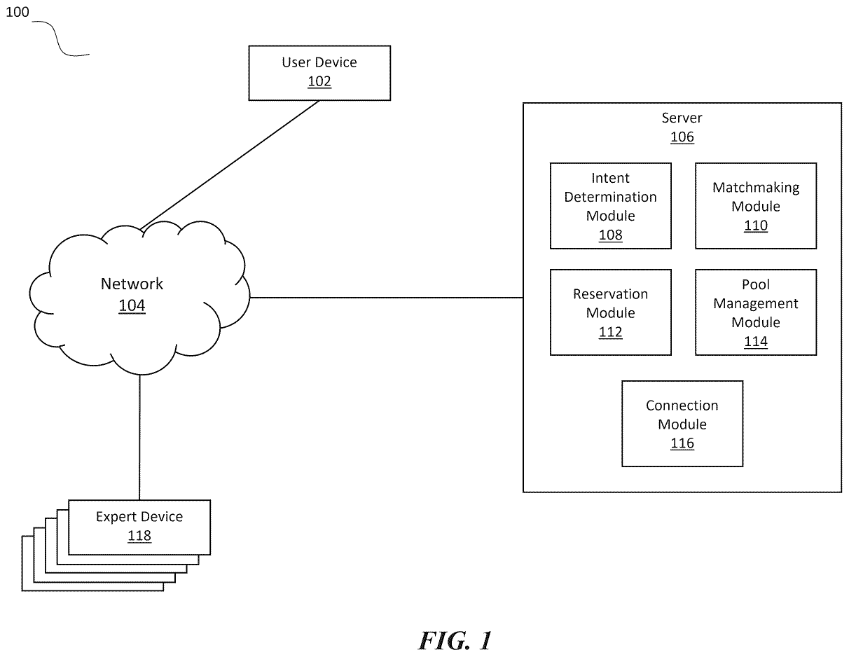

FIG. 1 is a block diagram of an example system 100 for routing expert connection requests according to example embodiments of the present disclosure. The system 100 can include one or more user devices 102 (generally referred to herein as a “user device 102” or collectively referred to herein as “user devices 102”) that can access a server 106 via a network 104 to facilitate communication and engage with an expert connection service that can initiate connections between the user device and a device of the plurality of expert devices 118. In some embodiments, the expert connection service of the server 106 can facilitate an efficient connection of the user device 102 with an expert device 118 based on the connection request received from the user device 102. For example, the user of the user device 102 can have a specific task in mind with regard to a tax filing and may wish to speak directly with a professional tax expert. However, of the various experts 118, certain experts will have different specialties, language proficiencies, and other differences such that they are more likely to assist the user than others. The server 106 therefore can utilize its various modules to identify relevant experts, reserve them in a pooling system, and ultimately initiate a connection, while still allowing for additional connection requests to be handled and walk-in/call-in users to be handled.

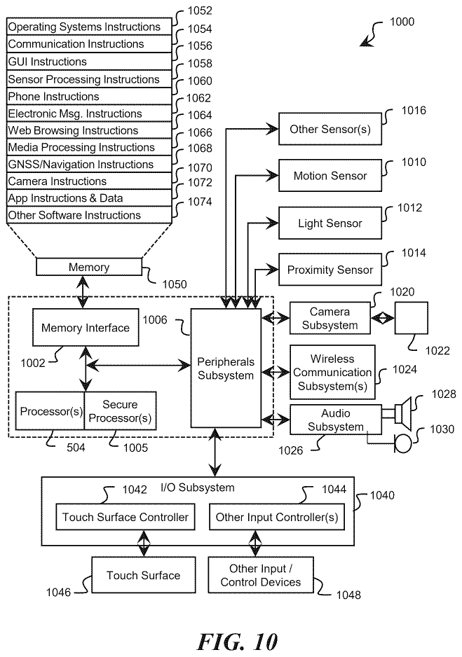

A user device 102 and/or the expert device 118 can include one or more computing devices capable of receiving user input, transmitting and/or receiving data via the network 104, and or communicating with the server 106. In some embodiments, a user device 102 and/or the expert device 118 can be a conventional computer system, such as a desktop or laptop computer. Alternatively, a user device 102 and/or the expert device 118 can be a device having computer functionality, such as a personal digital assistant (PDA), a mobile telephone, a smartphone, or other suitable device. In some embodiments, a user device 102 and/or the expert device 118 can be the same as or similar to the computing device 1000 described below with respect to FIG. 10.

The network 104 can include one or more wide areas networks (WANs), metropolitan area networks (MANs), local area networks (LANs), personal area networks (PANs), or any combination of these networks. The network 104 can include a combination of one or more types of networks, such as Internet, intranet, Ethernet, twisted-pair, coaxial cable, fiber optic, cellular, satellite, IEEE 801.11, terrestrial, and/or other types of wired or wireless networks. The network 104 can also use standard communication technologies and/or protocols.

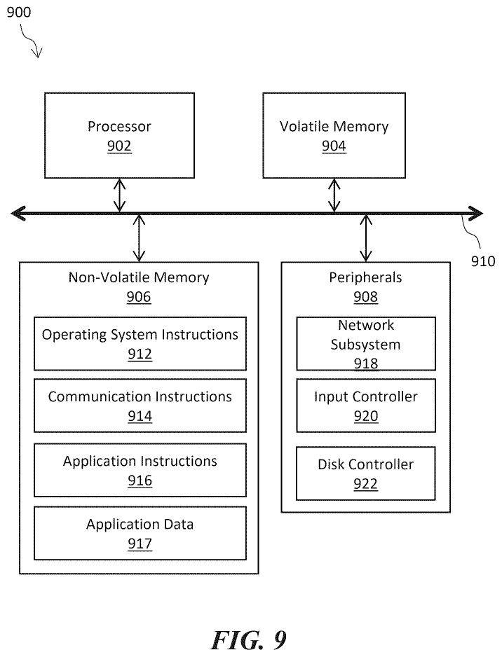

The server 106 may include any combination of one or more of web servers, mainframe computers, general-purpose computers, personal computers, or other types of computing devices. The server 106 may represent distributed servers that are remotely located and communicate over a communications network, or over a dedicated network such as a local area network (LAN). The server 106 may also include one or more back-end servers for carrying out one or more aspects of the present disclosure. In some embodiments, the server 106 may be the same as or similar to server 900 described below with respect to FIG. 9.

As shown in FIG. 1, the server 106 can include an intent determination module 108, a matchmaking module 110, a reservation module 112, a pool management module 114, and a connection module 116.

In some embodiments, the intent determination module 108 can be configured to analyze an incoming connection request from a user device 102 to determine an associated level of intent of the request. In some embodiments, the intent can indicate a likelihood that the user associated with the request will actually proceed to accept and initiate a connection with one of the expert devices 118. In some embodiments, the intent determination module 108 can analyze the channel through which the connection request originated. Example channels can include CRM and email campaigns, Google® or Yelp® listings, digital media campaigns, physical billboards with QR codes, in-product, marketing pages, friend/family referrals, and/or social media marketing. In some embodiments, the intent determination module 108 can analyze answers that the user submitted in response to various initial questions displayed on the user device 102, as well as time values associated with such answers. In some embodiments, the intent determination module 108 can receive and analyze time spent by the user reviewing individual expert profiles. For example, in instances where a user spends time reviewing an individual expert's profile and navigates to the connection portal to submit a request directly from the profile, the intent determination module 108 can identify this as a request with higher intent than a request that came through a more generic website with a quick navigation through various questions.

In some embodiments, the matchmaking module 110 can be configured to identify one or more experts from a pool of experts that match to a connection request received from the user device 102. In some embodiments, the matching can be performed on various criteria, such as past interaction data, subject matter expertise, language proficiency, and other relevant factors. For example, each of the experts within the expert pool (e.g., experts associated with the expert devices 118) can include certain profile information available, such as their language proficiency, areas of specialty, and other information. Moreover, the incoming connection request can include various parameters, such as information describing the user's preferences, such as the particular problem they need help with, as well as a desired language. In some embodiments, the matchmaking module 110 can transmit a list of the identified experts to the reservation module 112. In addition, the list of the identified experts can be transmitted to the user device 102 for display, such that the user can view the options and make a selection. In some embodiments, the matchmaking module 110 can also be configured to take advantage of external data sources (e.g., financial institutions, payroll providers such as ADP, prior year data for the customer, etc.) to determine their tax situation and then route them to the right expert. In some embodiments, the matchmaking module 110 can also determine the availability channel (e.g., phone, video, etc.), as well as recency (now, future, etc.) to find the right expert. In some embodiments, compliance requirements for a specific location and the location itself can play a role in finding the expert; for example, some customers may prefer a local expert. In addition, a feedback loop can also be employed by the matchmaking module 110 that enables the prioritization of experts that can yield the highest conversion from past conversion data.

In some embodiments, the reservation module 112 can place the experts from the identified list of experts in a waiting pool where they are “reserved.” During this reservation period, these experts can be inaccessible to walk-in customers or other standard routing mechanisms. However, in some embodiments, the experts can still be available to be identified as a list of matching experts for subsequent connection requests received from other user devices 102. In some embodiments, the identified experts can be kept in the waiting pool for a predefined period of time, such as 5-10 minutes, although this is merely exemplary in nature. In some embodiments, the length of the reservation period can be configurable based on various system requirements and customer wait time expectations. In some embodiments, once the reservation period has expired, the experts can be moved back into the regular pool of experts (i.e., where they are now available to be matched to walk-ins/call-ins). In some embodiments, as discussed above, walk-in/call-in customers and non-specific routing queues can be barred from accessing experts within the pool of available experts. In some embodiments, this barring can be achieved by assigning the experts a separate routing profile and keeping the pool mapped to that routing profile. In some embodiments, the barring can be achieved by assigning the expert a runtime attribute and walk-in/call-in requests can be stamped with a conflicting attribute match.

In some embodiments, the pool management module 114 can be configured to monitor the waiting pool of experts. For example, the pool management module 114 can monitor the availability of a total number of experts (i.e., experts that are not in the waiting pool) to ensure that an overall percentage of experts that are available for walk-ins/call-ins remains above a certain predefined threshold, such as about 80%. In some embodiments, maintaining the availability of experts at relatively high level can help ensure that the level of service to users walking in/calling in does not suffer at the cost of expert reservation. In some embodiments, the pool management module 114 is also configured to implement various collision prevention mechanisms. For example, the pool management module 114 can maintain a count of how many users each expert is matched with for a set time window. This count can be stored as an impression count and, once it reaches a pre-configured threshold, the associated expert can be removed from the list of available experts. In some embodiments, the impression count threshold can be configured to exclusively reserve one expert per user or one expert per N number of users. In some embodiments, the pool management module 114 can be configured to cause an expert to be “invisible,” such as when they are handling non-customer facing activities (e.g., tax preparation, training, internal meetings, etc.)

In some embodiments, the connection module 116 can, in response to a user making a selection of a displayed expert with user device 102, route a call to initiate a connection between the selected expert device 118 and the user device 102. In some embodiments, call routing can be performed via Amazon@ Web Services (AWS) connect preferred expert routing or via a personal queue. In some embodiments, this can ensure that the user device 102 is connected to an expert device 118 that meets their preferences, ultimately leading to enhanced satisfaction and efficient resolution of user queries.

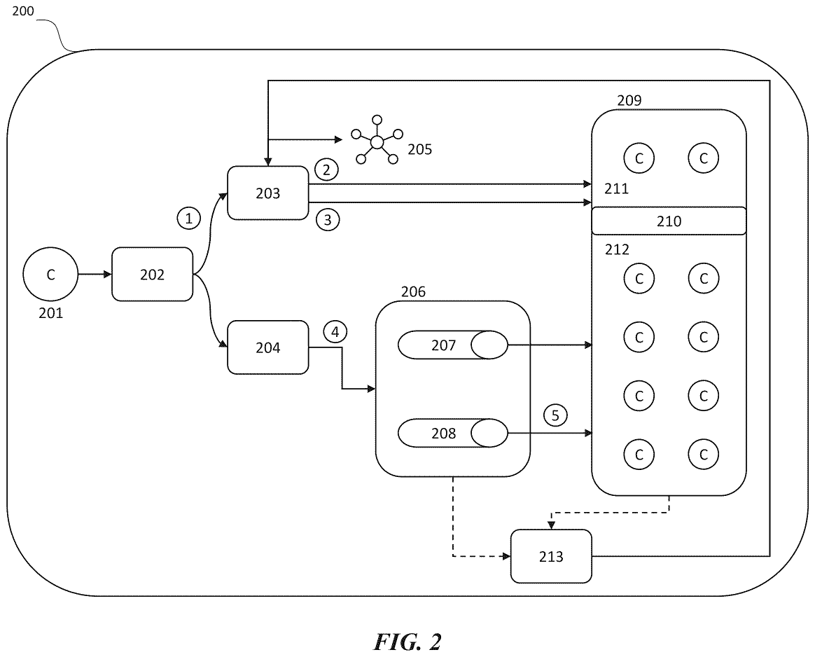

FIG. 2 is an example flow diagram 200 for routing expert connection requests within the system of FIG. 1 according to example embodiments of the present disclosure. At (1), a user 201 (e.g., via user device 102) can reach out to an expert connection service to obtain technical help from an expert or other type of support agent. For example, the user may wish to ask specific tax questions related to a tax return or other tax filing, certain financial questions, or any question that is part of a specific subject matter area with associated experts or agents. The user can utilize a customer user interface 202 to initiate the expert connection request. At (2), a matchmaking step 203 can be performed. For example, the matchmaking module 110 can identify a list of experts from the expert pool 212 that are relevant to the user's connection request.

At (3), the matchmaking step 203 can include the intent determination module 108 invoking a model 205 to determine the likelihood of the user going ahead with connecting to one of the potential identified experts. The identified list of experts (identified by the matchmaking module 110) can be placed by the reservation module 112 into a waiting pool 211, which can be separated from the main pool 212 of experts by a flex virtual barrier 210. In some embodiments, the identified experts may only be placed in the waiting pool if the pool threshold is not already met. Moreover, if an expert was already in the waiting pool 211 when they were identified, their impression count can be updated, such as by the pool management module 114. In some embodiments, if an expert's impression count is over the pre-configured threshold, then the management module 114 can opt to select the next matched expert. The list of available experts can then ultimately be displayed on the user interface 202.

At (4), the user can, via the user interface 202, select one of experts to be matched with. Then, the routing system 206, which can include a walk-in/call-in queue 207 of users and the directly connecting queue 208 of users, can, via the connection module 116, route the call to initiate the connection between the selected expert and the user 201. In some embodiments, this matching can be performed for multiple customers simultaneously, consistent with the embodiments discussed herein. In some embodiments, the connection module 116 can use preferred expert routing to connect the expert with the user and, in case of collision, an error can be returned to the user or a fallback option can be executed. In some embodiments, the fallback option can include detecting a remaining time of current work that the selected expert is performing and communicated to the user device 102. If the user opts for a callback option, the expert can get moved to the waiting pool 211, protected from walk-ins/call-ins. In addition, a demand supply balancer 213 can monitor overall demand volume across channels (direct connections or walk-ins/call-ins), as well as available supply of experts to determine an appropriate threshold for the pool 212.

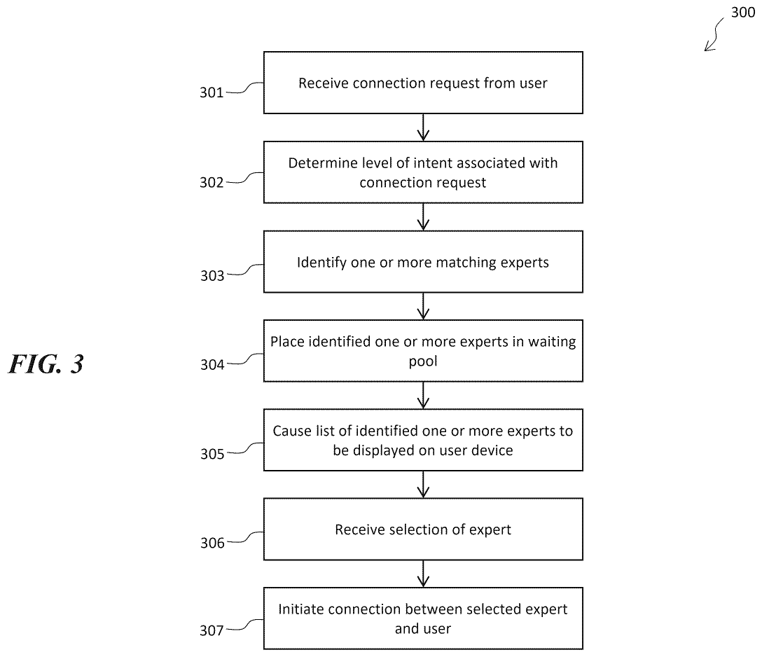

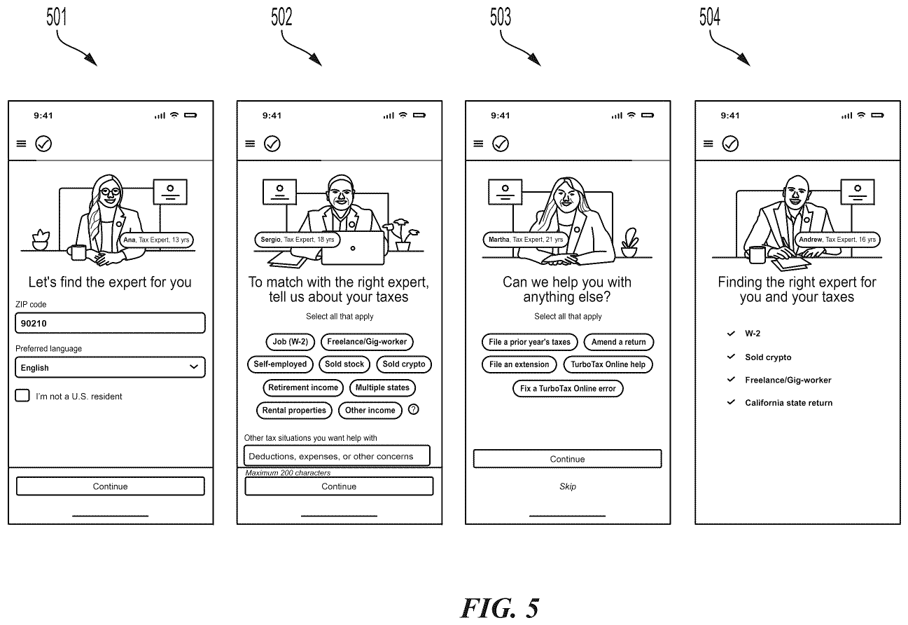

FIG. 3 is a flowchart of an example process 300 for routing expert connection requests according to example embodiments of the present disclosure. In some embodiments, the process 300 can be performed within the system 100 of FIG. 1, such as by the server 106 and its various modules. At block 301, the process 300 can include receiving a connection request from a user device 102. For example, a user associated with the user device 102 can submit a request indicating they wish to connect with an expert or other type of agent to receive assistance, such as with a tax filing, financial problem, or other type of issue. In some embodiments, the connection request can be accompanied by various information, such as a type of assistance that is desired, a desired language proficiency, or other similar parameters. In addition, the connection request can be accompanied by answers to various questions that have been displayed on the user device (see FIG. 5) and time associated with the questions.

At block 302, the process 300 can include determining, via the intent determination module 108, a level of intent associated with the connection request. In some embodiments, determining the level of intent associated with the connection request can include analyzing the connection request to determine a likelihood that the user associated with the request will proceed to accept and initiate a connection with one of the expert devices 118. In some embodiments, the intent determination module can analyze one or more of the channels through which the connection request originated, answers that the user submitted in response to various initial questions displayed on the user device 102, time values associated with such answers, and time spent by the user reviewing individual expert profiles. As an example, in instances where a user spends time reviewing an individual expert's profile and navigates to the connection portal to submit a request directly from the profile, the intent determination module 108 can identify this as a request with higher intent than a request that came through a more generic website with a quick navigation through various questions.

At block 303, the process 300 can include identifying, via the matchmaking module 110, one or more experts matching the connection request. In some embodiments, the identifying can be performed based on various criteria, such as past interaction data, subject matter expertise, language proficiency, and other relevant factors. In addition, other factors related to the selection of experts that can be taken into account include skills and proficiencies to handle certain types of situations (i.e., quality), the speed at which they can deliver a correct result to the user (i.e., efficiency), availability (i.e., an expert may not actually be available for various reasons to address the request), etc. Such factors related to the individual capabilities of experts can, in some embodiments, be important for identifying experts matching the request.

At block 304, the process 300 can include placing, via the reservation module 112, the one or more identified matching experts into a waiting pool where they are reserved. In some embodiments, the identified experts can be inaccessible to walk-in customers or other standard routing mechanisms during the reservation period. In some embodiments, the experts, despite being in the waiting pool and unable to match with walk-in/call-in users, can still be available to be identified within a list for subsequent connection requests received from other user devices 102. In some embodiments, the identified experts can be kept in the waiting pool for a predefined period of time, such as 5-10 minutes, although this is merely exemplary in nature. In some embodiments, the length of the reservation period can be configurable based on various system requirements and customer wait time expectations. In some embodiments, the reservation module 112 may only place the identified experts into the waiting pool in response to the determined level of intent being above a predefined threshold.

At block 305, the process 300 can include causing a list of the one or more identified experts to be displayed on the user device 102. At block 306, the process 300 can include receiving a selection of an expert from the list made via the user device 102. At block 307, the process 300 can include initiating, via the connection module 116, a connection between the selected expert device 118 and the user device 102.

In some embodiments, as discussed in relation to FIG. 1, during the process 300, other operations may be performed to maximize efficiency of the system, reduce latency, and optimize idle time. For example, in some embodiments, once the reservation period has expired, the experts can be moved back into the regular pool of experts (i.e., where they are now available to be matched to walk-ins/call-ins). In some embodiments, during the process 300, the pool management module 114 can monitor the waiting pool of experts. For example, the pool management module 114 can monitor the availability of a total number of experts (i.e., experts that are not in the waiting pool) to ensure that an overall percentage of experts that are available for walk-ins/call-ins remains above a certain predefined threshold. In some embodiments, the pool management module 114 can also implement various collision prevention mechanisms, such as maintaining an impression count of how many users each expert is matched with for a set time window. Once the impression count reaches a pre-configured threshold, the associated expert can be removed from the list of available experts. In some embodiments, during the process 300, in addition to automated supply efficiency management, the system 100 can also provide various manual levers for an operations team to allow movement of experts across various products and channels, which can enable considerations of signals outside the system boundaries. Moreover, the system 100 can provide ways to monitor the supply side of experts (e.g., customer contact queue wait times, proficiency levels of available experts correlated to demand, pending work to catchup by experts like tax-prep, etc.).

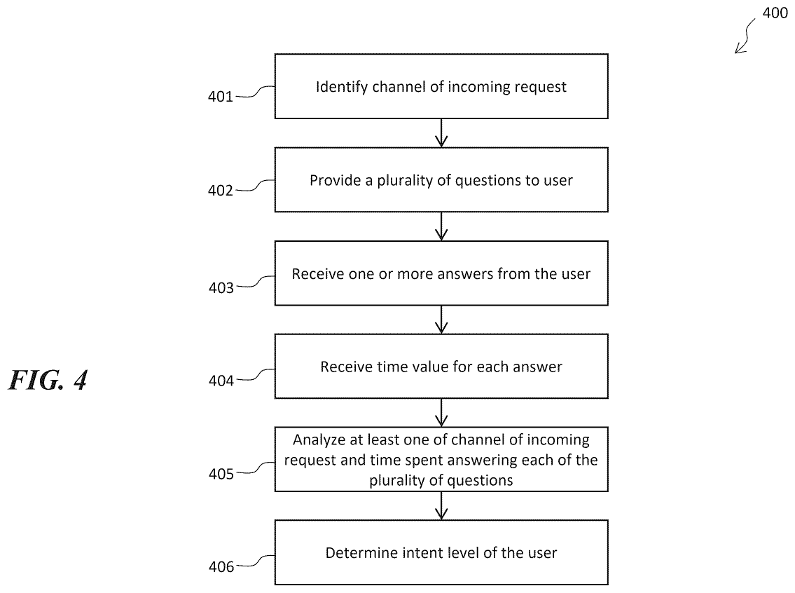

FIG. 4 is another flowchart of an example process 400 for routing expert connection requests according to example embodiments of the present disclosure. In some embodiments, the process 400 can be performed by the intent determination module during the process 300, such as at block 302 to determine a level of intent of the incoming connection request. At block 401, the process can include identifying a channel of the incoming request. At block 402, the process 400 can include providing a plurality of questions to the user to be displayed on the user device 102. At block 403, the process 400 can include receiving one or more answers from the user that are responsive to the questions that have been displayed. At block 404, the process 400 can include receiving a time value associated with each answer provided by the user. At block 405, the process 400 can include analyzing at least one of the channels of the incoming request and the time spent answering each of the plurality of questions. In some embodiments, the analyzing can also include analyzing a time spent reviewing one or more expert profiles. At block 406, the process 400 can include determining an intent level of the user's connection request. In some embodiments, the intent determination module 108 can utilize other ways to understand the user outside of a list of questions, such as data imported from financial institutions and payroll providers, prior year interaction data, and/or IRS tax transcripts.

In some embodiments, the analyzing can be performed using a rule-based model. In some embodiments, the output of the analyzing (i.e., the determined intent level of the user) can be output directly into the system such that the reservation module 112 creates the waiting pool of experts. In other embodiments, the determined intent level may be displayed on a user device within the system 100, such as to an expert or other personnel monitoring the system.

FIGS. 5-8 are example user interfaces that can be displayed during the processes for routing expert connection requests according to example embodiments of the present disclosure. In particular, FIG. 5 shows interfaces 501-504 which are exemplary interfaces displayed on a user device 102 for eliciting information from a user while a connection request is being prepared in order to match the request to various experts. For example, in interface 501, the user is being prompted to input a ZIP code and a preferred language, as well as identify whether they are a US citizen or not. In interface 502, the user is being prompted to provide information describing the state of their tax return, as well as a free-text bubble to type information in manually. In interface 503, additional options are displayed to the user that may be selected as being a relevant issue. In interface 504, the user is informed that the system is processing the connection request to match the request with certain experts.

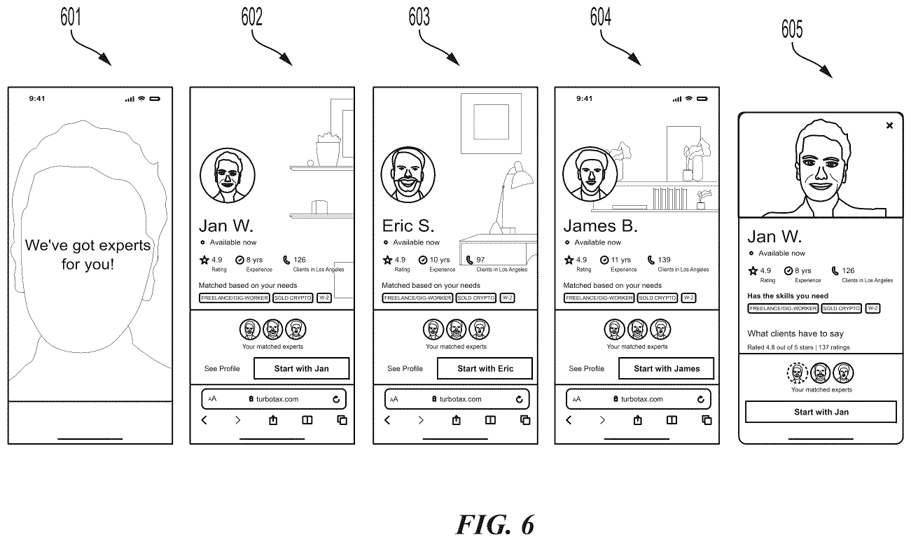

FIG. 6 shows interfaces 601-605 which are exemplary interfaces displayed on a user device 102 for matching the user with an expert. The interfaces illustrate potential experts and their associated profiles so that the user may individually select one if they wish. In order to select one, the user would click the “start with” button for one of the experts, and this would trigger a connection request to be sent to the server 106.

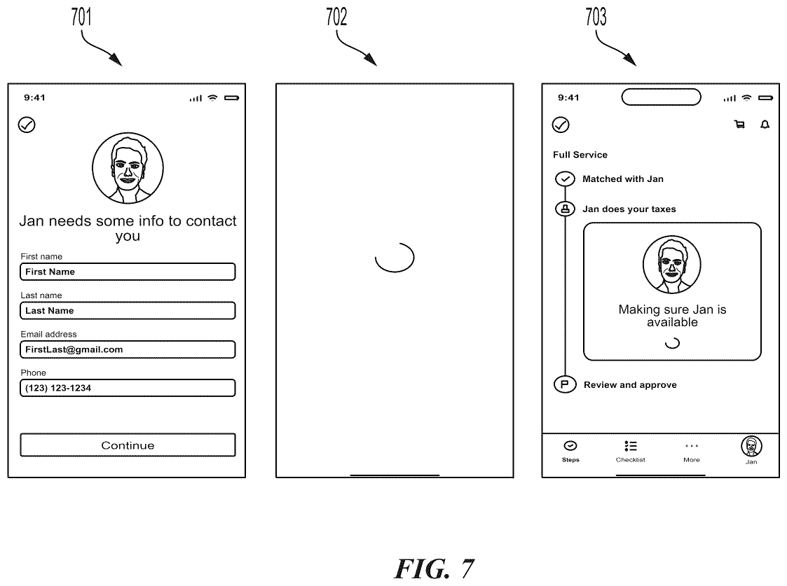

FIG. 7 shows interfaces 701-703 which are exemplary interfaces displayed on a user device after a user has selected a match. For example, the user can have selected Jan as their desired expert from the list of matching experts displayed on the user device 102. In interface 701, the user is prompted to provide contact information, the interface 702 includes a loading screen after submission, and the interface 703 indicates the connection is being initiated by the connection module 116.

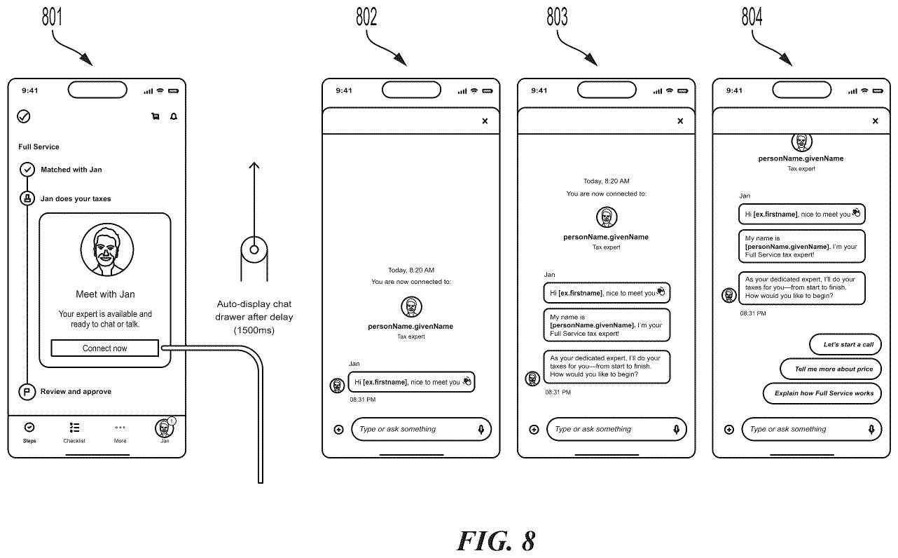

FIG. 8 shows interfaces 801-804 which are exemplary interfaces displayed on a user device 102 after a user has selected a match. If a user selects the “connect now” option on interface 801, direct chat connection functionality is initiated between the expert device 118 and the user device 102.

FIG. 9 is a diagram of an example computing device or server device. Server 900 can implement various features and processes as described herein. Server 900 can be implemented on any electronic device that runs software applications derived from complied instructions, including without limitation personal computers, servers, smart phones, media players, electronic tablets, game consoles, email devices, etc. In some implementations, server 900 can include one or more processors 902, volatile memory 904, non-volatile memory 906, and one or more peripherals 908. These components can be interconnected by one or more computer buses 910.

Processor(s) 902 can use any known processor technology, including but not limited to graphics processors and multi-core processors. Suitable processors for the execution of a program of instructions can include, by way of example, both general and special purpose microprocessors, and the sole processor or one of multiple processors or cores, of any kind of computer. Bus 910 can be any known internal or external bus technology, including but not limited to ISA, EISA, PCI, PCI Express, USB, Serial ATA, or FireWire. Volatile memory 904 can include, for example, SDRAM. Processor 902 can receive instructions and data from a read-only memory or a random access memory or both. Essential elements of a computer can include a processor for executing instructions and one or more memories for storing instructions and data.

Non-volatile memory 906 can include by way of example semiconductor memory devices, such as EPROM, EEPROM, and flash memory devices; magnetic disks such as internal hard disks and removable disks; magneto-optical disks; and CD-ROM and DVD-ROM disks. Non-volatile memory 906 can store various computer instructions including operating system instructions 912, communication instructions 914, application instructions 916, and application data 917. Operating system instructions 912 can include instructions for implementing an operating system (e.g., Mac OS®, Windows®, or Linux). The operating system can be multi-user, multiprocessing, multitasking, multithreading, real-time, and the like. Communication instructions 914 can include network communications instructions, for example, software for implementing communication protocols, such as TCP/IP, HTTP, Ethernet, telephony, etc. Application instructions 916 can include instructions for various applications. Application data 917 can include data corresponding to the applications.

Peripherals 908 can be included within server device 900 or operatively coupled to communicate with server device 900. Peripherals 908 can include, for example, network subsystem 918, input controller 920, and disk controller 922. Network subsystem 918 can include, for example, an Ethernet of WiFi adapter. Input controller 920 can be any known input device technology, including but not limited to a keyboard (including a virtual keyboard), mouse, track ball, and touch-sensitive pad or display. Disk controller 922 can include one or more mass storage devices for storing data files; such devices include magnetic disks, such as internal hard disks and removable disks; magneto-optical disks; and optical disks.

FIG. 10 is another example of a computing device. The illustrative user device 1000 can include a memory interface 1002, one or more data processors, image processors, central processing units 1004, and or secure processing units 1005, and peripherals subsystem 1006. Memory interface 1002, one or more central processing units 1004 and or secure processing units 1005, and or peripherals subsystem 1006 can be separate components or can be integrated in one or more integrated circuits. The various components in user device 1000 can be coupled by one or more communication buses or signal lines.

Sensors, devices, and subsystems can be coupled to peripherals subsystem 1006 to facilitate multiple functionalities. For example, motion sensor 1010, light sensor 1012, and proximity sensor 1014 can be coupled to peripherals subsystem 1006 to facilitate orientation, lighting, and proximity functions. Other sensors 1016 can also be connected to peripherals subsystem 1006, such as a global navigation satellite system (GNSS) (e.g., GPS receiver), a temperature sensor, a biometric sensor, magnetometer, or other sensing device, to facilitate related functionalities.

Camera subsystem 1020 and optical sensor 1022, e.g., a charged coupled device (CCD) or a complementary metal-oxide semiconductor (CMOS) optical sensor, can be utilized to facilitate camera functions, such as recording photographs and video clips. Camera subsystem 1020 and optical sensor 1022 can be used to collect images of a user to be used during authentication of a user, e.g., by performing facial recognition analysis.

Communication functions can be facilitated through one or more wired and or wireless communication subsystems 1024, which can include radio frequency receivers and transmitters and or optical (e.g., infrared) receivers and transmitters. For example, the Bluetooth (e.g., Bluetooth low energy (BTLE)) and or WiFi communications described herein can be handled by wireless communication subsystems 1024. The specific design and implementation of communication subsystems 1024 can depend on the communication network(s) over which the user device 1000 is intended to operate. For example, user device 1000 can include communication subsystems 1024 designed to operate over a GSM network, a GPRS network, an EDGE network, a WiFi or WiMax network, and a Bluetooth™ network. For example, wireless communication subsystems 1024 can include hosting protocols such that device 1000 can be configured as a base station for other wireless devices and or to provide a WiFi service.

Audio subsystem 1026 can be coupled to speaker 1028 and microphone 1030 to facilitate voice-enabled functions, such as speaker recognition, voice replication, digital recording, and telephony functions. Audio subsystem 1026 can be configured to facilitate processing voice commands, voice-printing, and voice authentication, for example.

I/O subsystem 1040 can include a touch-surface controller 1042 and or other input controller(s) 1044. Touch-surface controller 1042 can be coupled to a touch-surface 1046. Touch-surface 1046 and touch-surface controller 1042 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch-surface 1046.

The other input controller(s) 1044 can be coupled to other input/control devices 1048, such as one or more buttons, rocker switches, thumb-wheel, infrared port, USB port, and or a pointer device such as a stylus. The one or more buttons (not shown) can include an up/down button for volume control of speaker 1028 and or microphone 1030.

In some implementations, a pressing of the button for a first duration can disengage a lock of touch-surface 1046; and a pressing of the button for a second duration that is longer than the first duration can turn power to user device 1000 on or off. Pressing the button for a third duration can activate a voice control, or voice command, module that enables the user to speak commands into microphone 1030 to cause the device to execute the spoken command. The user can customize a functionality of one or more of the buttons. Touch-surface 1046 can, for example, also be used to implement virtual or soft buttons and or a keyboard.

In some implementations, user device 1000 can present recorded audio and or video files, such as MP3, AAC, and MPEG files. In some implementations, user device 1000 can include the functionality of an MP3 player, such as an iPod™ User device 1000 can, therefore, include a 36-pin connector and or 8-pin connector that is compatible with the iPod. Other input/output and control devices can also be used.

Memory interface 1002 can be coupled to memory 1050. Memory 1050 can include high-speed random access memory and or non-volatile memory, such as one or more magnetic disk storage devices, one or more optical storage devices, and or flash memory (e.g., NAND, NOR). Memory 1050 can store an operating system 1052, such as Darwin, RTXC, LINUX, UNIX, OS X, Windows, or an embedded operating system such as VxWorks.

Operating system 1052 can include instructions for handling basic system services and for performing hardware dependent tasks. In some implementations, operating system 1052 can be a kernel (e.g., UNIX kernel). In some implementations, operating system 1052 can include instructions for performing voice authentication.

Memory 1050 can also store communication instructions 1054 to facilitate communicating with one or more additional devices, one or more computers and or one or more servers. Memory 1050 can include graphical user interface instructions 1056 to facilitate graphic user interface processing; sensor processing instructions 1058 to facilitate sensor-related processing and functions; phone instructions 1060 to facilitate phone-related processes and functions; electronic messaging instructions 1062 to facilitate electronic messaging-related process and functions; web browsing instructions 1064 to facilitate web browsing-related processes and functions; media processing instructions 1066 to facilitate media processing-related functions and processes; GNSS/Navigation instructions 1068 to facilitate GNSS and navigation-related processes and instructions; and or camera instructions 1070 to facilitate camera-related processes and functions.

Memory 1050 can store application (or “app”) instructions and data 1072, such as instructions for the apps described above in the context of FIGS. 1-8. Memory 1050 can also store other software instructions 1074 for various other software applications in place on device 1000.

The described features can be implemented in one or more computer programs that can be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions can include, by way of example, both general and special purpose microprocessors, and the sole processor or one of multiple processors or cores, of any kind of computer. Generally, a processor can receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail may be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1. A computer-implemented method, performed by at least one processor, comprising:
receiving a connection request from a user to interface with an expert;
determining a level of intent associated with the connection request, the level of intent indicating a likelihood that the user will connect to the expert, with a first level of intent based on the user's direct request through the expert's profile webpage and a second level of intent based on the user's request through a generic webpage, the first level of intent being higher than the second level of intent;
identifying one or more expert devices from an expert pool matching the connection request;
placing the one or more identified expert devices in a waiting pool specifically for the user in accordance with the determined level of intent, wherein the one or more identified expert devices is placed in the waiting pool for a predefined period of time, preventing the one or more expert devices from being used by a walk-in/call-in channel during the predefined period of time, based on an identified wait time expectation associated with the connection request;
causing a list of expert profiles of the one or more identified expert devices to be displayed on a user device associated with the user;
receiving a selection of an expert profile from the list of expert profiles;
initiating a connection between the expert device of the selected expert profile and the user device;
maintaining a count of a number of connection requests matched to each expert device; and
in response to the count exceeding a predefined threshold, preventing the expert device from being placed into the waiting pool.

2. The computer-implemented method of claim 1, wherein placing the one or more identified expert devices in the waiting pool comprises placing the one or more identified expert devices in the waiting pool in response to determining that the level of intent associated with the connection request is above a predefined threshold.

3. The computer-implemented method of claim 2, wherein determining the level of intent associated with the connection request comprises:
identifying a channel of the connection request;
providing a plurality of questions to the user device;
receiving one or more answers from the user device;
receiving a time value associated with each of the one or more answers;
analyzing at least one of the identified channel and the received one or more time values; and
determining the level of intent based on the analysis.

4. The computer-implemented method of claim 3, wherein analyzing at least one of the identified channel and the received one or more time values comprises applying a rule-based model.

5. The computer-implemented method of claim 3, wherein analyzing at least one of the identified channel and the received one or more time values comprises applying a machine-learning model.

6. The computer-implemented method of claim 1, wherein placing the one or more identified expert devices in the waiting pool comprises reserving the one or more identified expert devices such that each of the one or more identified expert devices is inaccessible to subsequent connection requests.

7. (canceled)

8. (canceled)

9. The computer-implemented method of claim 1 comprising:
monitoring an availability percentage of the expert pool; and
in response to identifying that the availability percentage is below a predefined threshold, preventing an expert device from being placed into the waiting pool.

10. (canceled)

11. A computing system comprising:
a processor; and
a non-transitory computer-readable storage device storing computer-executable instructions, the instructions when executed by the processor cause the processor to perform operations comprising:
receiving a connection request from a user to interface with an expert;
determining a level of intent associated with the connection request, the level of intent indicating a likelihood that the user will connect to the expert, with a first level of intent based on the user's direct request through the expert's profile webpage and a second level of intent based on the user's request through a generic webpage, the first level of intent being higher than the second level of intent;
identifying one or more expert devices matching the connection request;
placing the one or more identified expert devices in a waiting pool specifically for the user device in accordance with the determined level of intent, wherein the one or more identified expert devices is placed in the waiting pool for a predefined period of time, preventing the one or more expert devices from being used by a walk-in/call-in channel during the predefined period of time, based on an identified wait time expectation associated with the connection request;
causing a list of expert profiles of the one or more identified expert devices to be displayed on a user device associated with the user;
receiving a selection of an expert profile from the list of expert profiles;
initiating a connection between the expert device of the selected expert profile and the user device;
maintaining a count of a number of connection requests matched to each expert device; and
in response to the count exceeding a predefined threshold, preventing the expert device from being placed into the waiting pool.

12. The computing system of claim 11, wherein placing the one or more identified expert devices in the waiting pool comprises placing the one or more identified expert devices in the waiting pool in response to determining that the level of intent associated with the connection request is above a predefined threshold.

13. The computing system of claim 12, wherein determining the level of intent associated with the connection request comprises:
identifying a channel of the connection request;
providing a plurality of questions to the user device;
receiving one or more answers from the user device;
receiving a time value associated with each of the one or more answers;
analyzing at least one of the identified channel and the received one or more time values; and
determining the level of intent based on the analysis.

14. The computing system of claim 13, wherein analyzing at least one of the identified channel and the received one or more time values comprises applying a rule-based model.

15. The computing system of claim 13, wherein analyzing at least one of the identified channel and the received one or more time values comprises applying a machine-learning model.

16. The computing system of claim 11, wherein placing the one or more identified expert devices in the waiting pool comprises reserving the one or more identified expert devices such that each of the one or more identified expert devices is inaccessible to subsequent connection requests.

17. (canceled)

18. (canceled)

19. The computing system of claim 11 comprising:
monitoring an availability percentage of the expert pool; and
in response to identifying that the availability percentage is below a predefined threshold, preventing an expert device from being placed into the waiting pool.

20. (canceled)
